(19) United States
(12) Patent Application Publication
(10) Pub. No.: US 2022/0345190 A1
(43) Pub. Date: Oct. 27, 2022

(54) VEHICLE COMMUNICATION SYSTEM WITH DUAL TRANSMIT ANTENNAS

(71) Applicant: Honeywell International Inc., Charlotte, NC (US)

(72) Inventor: Andy Rowland, Ottawa (CA)

(73) Assignee: Honeywell International Inc., Charlotte, NC (US)

(21) Appl. No.: 17/237,765

(22) Filed: Apr. 22, 2021

(51) Int. Cl. H04B 7/06; H01Q 1/28

(52) U.S. Cl. CPC H04B 7/0682; H01Q 1/28

(57) ABSTRACT

A communication system for a vehicle is provided. The system includes a transmitter, first and second antennas and a splitter. The transmitter outputs transmission signals. The second antenna is spaced from the first antenna to provide spatial diversity between the transmission signals radiated out by the first and second antennas. The splitter has an input that is in communication with an output of the transmitter. The splitter has a first output that is in communication with the first antenna and a second output that is in communication with the second antenna. The splitter is configured to provide an unequal passive power splitting between the first output and the second output of the splitter.

### BACKGROUND

Aircraft air-to-ground communications have been developed to provide a secondary communication system to satellite communications. Air-to-ground communications are less costly and may provide greater throughput of data. Air-to-ground communications may be used to supplement satellite communications for non-critical data between the aircraft and a ground station, such as an air traffic control (ATC) station, aircraft operations station, internet provider or other type of base station. Further, air-to-ground communications may also be used to provide a datalink between passengers of the aircraft and ground stations.

An example of an air-to-ground communication system is a long-term evolution (LTE) communication system. The air-to-ground communication system typically includes an antenna mounted on the bottom of an aircraft to receive and transmit radio frequency (RF) LTE signals. LTE communication systems use ground-based antennas that are mounted on towers. The antennas mounted on the towers for such systems are slightly tilted upward (instead of slightly tilted downward for cellular communications) to communicate with aircraft mounted antenna on aircraft traveling overhead.

High speed turbine of aircraft engines may block RF signals, such as LTE signals, communicated between the aircraft and a ground station. Hence, an aircraft with engines below its wings may present communication issues when an engine of the aircraft is within a line of sight between the aircraft's antenna and an antenna on a ground station or tower. This interference may cause shadowing or complete blockage of transmitted signals from the aircraft antenna to the antenna associated with a ground station.

The blocking of signals transmitted from the ground is less of an issue with the use of diversity receivers at the aircraft or with ground stations using space time block coding available with LTE to simultaneously transmit from two spaced antennas. This allows a signal to be received at the aircraft without creating directional nulls due to interference from the simultaneously transmitted signals.

### SUMMARY

The following summary is made by way of example and not by way of limitation. It is merely provided to aid the reader in understanding some of the aspects of the subject matter described. Embodiments provide a communication system to deal with potential blocking of transmission signals by an element or object such as an engine of an aircraft.

In one embodiment, a communication system for a vehicle is provided. The system includes a transmitter, first and second antennas and a splitter. The transmitter outputs transmission signals. The second antenna is spaced from the first antenna to provide spatial diversity between the transmission signals radiated out by the first and second antennas. The splitter has an input that is in communication with an output of the transmitter. The splitter has a first output that is in communication with the first antenna and a second output that is in communication with the second antenna. The splitter is configured to provide an unequal passive power splitting between the first output and the second output of the splitter.

In another example embodiment, another communication system for a vehicle is provided. The system includes a transmitter to transmit transmission signals, a passive power splitter, first antenna and a second antenna. An input of the power splitter is in communication with the transmitter. The power splitter has a first output and a second output. The power splitter is configurated to provide an unequal power distribution between the first output and the second output. The first antenna is in communication with the first output of the power splitter. The second antenna is spaced from the first antenna and is in communication with the second output of the power splitter. The first and second antennas are configured to radiate the transmission signals to a remote location. A positioning of the first and second antennas allows the transmission signals to reach the remote location when at least a partial blockage of the transmission signal occurs as a result of at least one element of the vehicle causing at least one signal blockage area that blocks the radiation of the transmission signal from at least one of the first and second antennas to the remote location.

In yet another embodiment, a method of operating a vehicle communication system is provided. The method includes transmitting a transmission signal to be communicated to a remote location with a transmitter; splitting the transmission signal with a passive power splitter having unequal first and second outputs to generate a first split transmission signal of a first power from the first output and a second split transmission signal of a second different power from the second output; radiating out the first split transmission signal of the first power from a first antenna; and radiating out the second split transmission signal of the second power from second antenna that is spaced from the first antenna so that at least one of the first split transmission signal and the second split transmission will reach a remote location when an element of the vehicle blocks another of the first split transmission signal and the second split transmission signal.

### BRIEF DESCRIPTION OF THE DRAWINGS

Embodiments can be more easily understood and further advantages and uses thereof will be more readily apparent, when considered in view of the detailed description and the following figures in which:

FIG. 1 is a bottom view of an aircraft with a single antenna of the prior art illustrating engine blockage;

FIG. 2 is a front view of an aircraft with a single antenna of the prior art illustrating engine blockage;

FIG. 3 is a block diagram of a vehicle communication system with two antennas according to one exemplary embodiment;

FIG. 4 is an illustration of a destructive interference table;

FIG. 5 is a bottom view of an aircraft illustrating two antennas according to one exemplary embodiment; and

FIG. 6 is a communication flow diagram according to one exemplary embodiment.

In accordance with common practice, the various described features are not drawn to scale but are drawn to emphasize specific features relevant to the subject matter described. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the embodiments, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

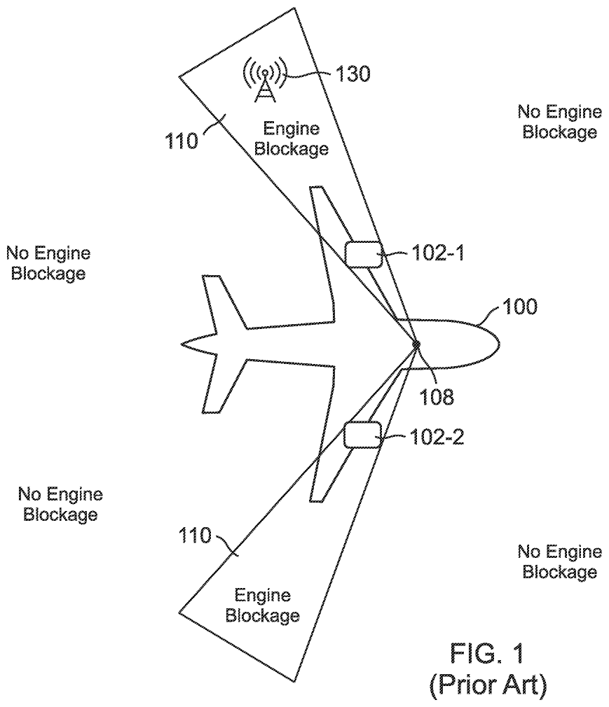

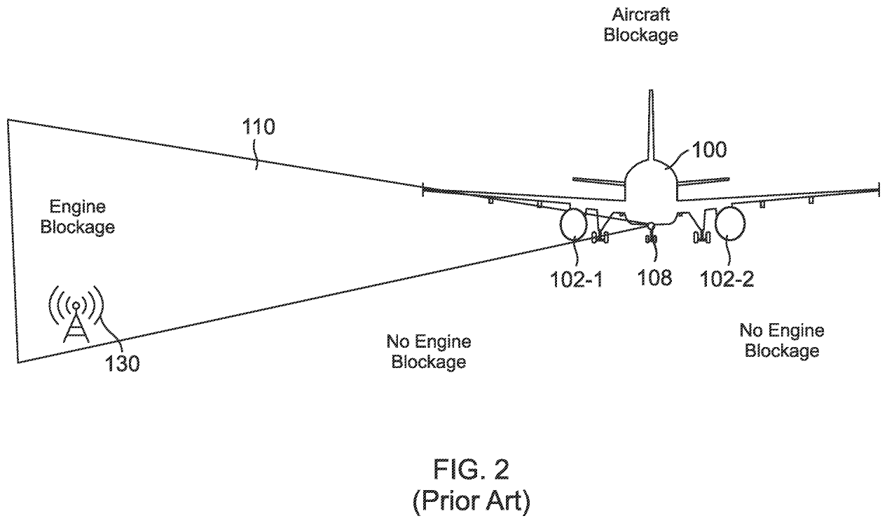

Embodiments provide a communication system to deal with potential blocking of transmission signals by an element or object such as an engine of an aircraft. Further background regarding the blockage of transmission signals in an aircraft example is provided in the prior art FIGS. 1 and 2. Referring to FIG. 1, a bottom portion of an aircraft 100 is illustrated. The communication system of aircraft 100 includes a single antenna 108 that is located on the bottom of the aircraft. The antenna 108 is used to radiate communication signals to a remote location such as a ground station 130 (which may include an antenna on a tower). As illustrated, engines 102-1 and 102-2 create engine blockage areas 110 in which the engines 102-1 and 102-2 interfere with the transmitted signals radiated out from the antenna 108. The position of the aircraft 100 relative to ground station 130 prevents a transmission signal radiated from the antenna 108 from reaching ground station 130 in this example due to the engine blockage area 110 caused by engine 102-1. Further, FIG. 2 illustrates that even when the aircraft 100 is on the ground, an engine 102-1 creates an engine blocking area 110 that may interfere with transmitted signals radiated out from the antenna 108 to the ground station 130.

One possible solution to deal with engine blockage areas 110 caused by engines is to add to the communication system a second transmitter and second antenna that is spaced from a first antenna. The system could then switch between transmitters and associated antennas based on possible signal blockage issues. However, the high cost associated with such a system may be prohibitive.

Further, a splitter may be used to split the transmitted signal from a transmitter into split transmission signals that are respectively communicated to two spaced independent antennas. This may avoid blockages from an engine but may result in the split transmission signal destructively interfering with each other causing nulls (the canceling out of the radio signals).

Embodiments of the present invention avoid nulls when using two antennas by using an unequal power splitter, so the signal power of the split transmitted signals are different. With the split transmitted signals having different powers, there can never be a perfect cancelation of the signals resulting in nulls. Even with a destructive interreference pattern (signals combining in anti-phase), the result will just be a reduced amplitude signal. As long as the reduced amplitude signal is still strong enough to be received and processed at a receiver (within the power link margin of the receiver) of the ground station, the transmitted signal by the aircraft's antenna will be communicated to the ground station.

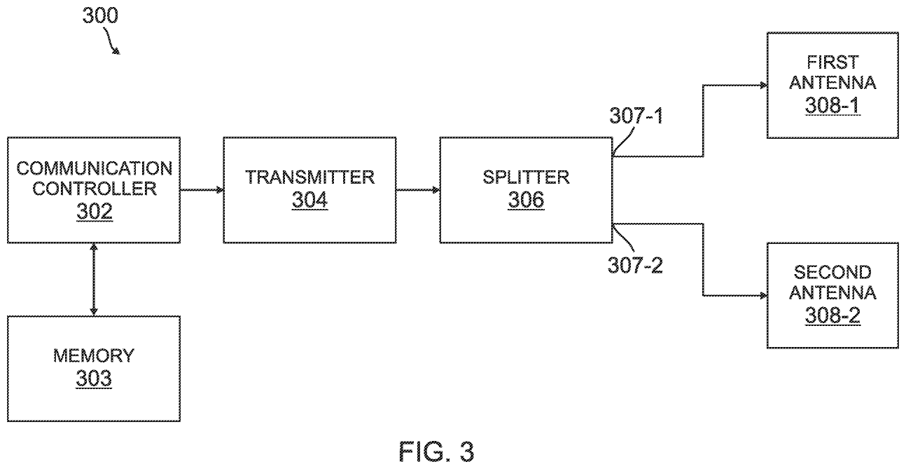

Referring to FIG. 3, a block diagram of a vehicle communication system 300 of one example embodiment that deals with engine blockage, or blockage form other elements of the vehicle, is provided. System 300 includes a memory 303 and a communication controller 302 that is configured to control a transmitter 304 to generate transmission signals.

In general, the communication controller 302 may include any one or more of a processor, microprocessor, a digital signal processor (DSP), an application specific integrated circuit (ASIC), a field program gate array (FPGA), or equivalent discrete or integrated logic circuitry. In some example embodiments, controller 302 may include multiple components, such as any combination of one or more microprocessors, one or more controllers, one or more DSPs, one or more ASICs, one or more FPGAs, as well as other discrete or integrated logic circuitry. The functions attributed to the controller herein may be embodied as software, firmware, hardware or any combination thereof. The controller 302 may be part of a system controller or a component controller. The memory 303 may include computer-readable operating instructions that, when executed by the controller 302 provides functions of the communication system 300. Such functions may include the functions of causing the transmitter 304 to generate transmission signals. The computer readable instructions may be encoded within the memory 303. Memory 303 is an appropriate non-transitory storage medium or media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

An output of the transmitter 304 is coupled to an input of a splitter 306. The splitter 306 splits each transmission signal into a first and second split transmission signal at a first and second output 307-1 and 307-2. The first split transmission signal is communicated to the first antenna 308-1 and the second split transmission signal is communicated to the second antenna 308-2. The splitter 306 provides unequal passive power splitting where, in an embodiment, a select power loss at one of the first and second outputs 307-1 or 307-2 is provided. Unlike, active power splitters that may amplify and phase shift the signals, the passive power splitter 306 of embodiments, is a technically simple and a low cost solution. Using the passive power splitter 306 does not amplify the transmission signal but simply provides a select power loss at one of the first and second outputs to provide power signal diversity between the first and second output of the splitter. The first and second antennas 308-1 and 308-2 are communicatively coupled to the respective outputs 307-1 and 307-2 of the splitter 306 to radiate out the respective first and second split transmission signals. The first and second antennas 308-1 and 308-2 are spaced from each other to provide spatial diversity. The spacing between the antennas 308-1 and 308-2 is selected to enable a signal radiated from one of the antennas to reach a desired remote location when an element of the vehicle, in which the antennas 308-1 and 308-2 are mounted, blocks the signal from the other antenna.

As discussed above, the splitter 306 provides an uneven power split (signal power diversity) to avoid serious signal reduction due to destructive interference between the split signals. Destructive interference occurs for equal power signals at a single RF frequency (continuous wave). With modulated RF signals, fast moving constructive and destructive interference patterns result. As discussed above, the unequal split in power, or signal power diversity, ensures the destruction is only partial when neither of the signals radiated from the antennas are block by an element of the vehicle.

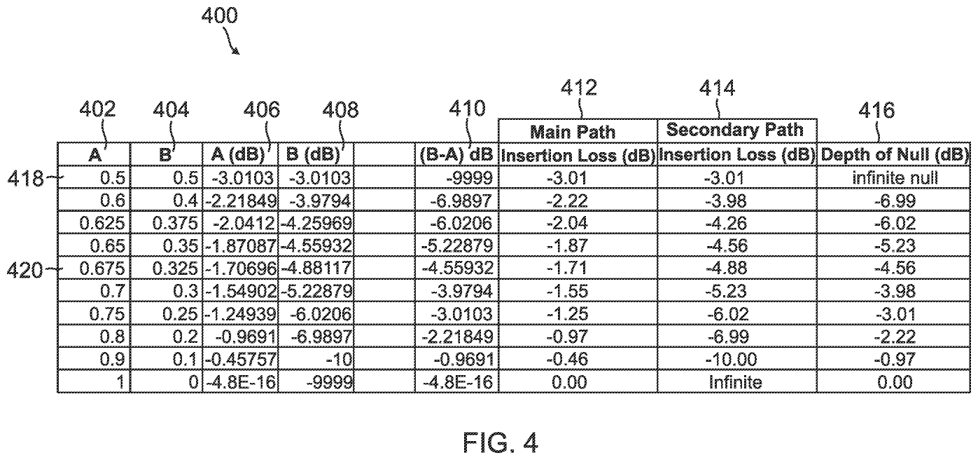

An example destructive interference table 400 for a continuous wave is illustrated FIG. 4. From this table, an acceptable power split between the outputs of the splitter may be selected. Column 402 illustrates a percentage of power provided to a first output of a splitter. Column 404 illustrates a percentage of power provided to a second output of the splitter. A+B in the table will always equal 1 (the total power available). Columns 406 and 408 illustrate a conversion of the percentages to dB units. For example, for the first row where the percentage is split in equal parts (.5) the associated dB is 10*log (0.5) which equals −3.0103 dB. When phases are added into the mix, a worst case phase is a difference of pi radians, or 180 degree out of phase.

Column 410 illustrates the resulting anti-phase combination of 10*log(B−A). For example, with respect to the first row, the anti-phase combination is found by 10*log (0.5−0.5) which will result in a complete null from complete antihalation. Column 412 includes the same information of column 406 which is the equivalent to an insertion loss in a main path. Column 414 includes the same information of column 408 which is the equivalent to an insertion loss in a secondary path. Further, column 416 is the same and column 410 which is the impact of two signals of the given split combined in anti-phase as if transmitted from two antenna.

The destructive interference table 400 illustrates in row 418 an equal split. At an equal split an infinite null occurs as illustrated in column 416. A desired split may be in row 420 where A equals 0.675 and B equals 0.325 which, as illustrated in table 400, is −1.70697 dB and −4.88117 dB in columns 406 and 408. Row 420 may provide an optimum split with a reduced null (destruction limited to −4.56 dB) and a reduced power loss of −4.88db (coupling loss) in the second path. In this example the first antenna would receive 67.5% of the available signal power while the second antenna would receive 32.5% of the signal power (where 67.5% is equal to −1.71 dB and 32.5% is equal to −4.88 dB). The unequal power split of the transmitted signals will still be within a power link margin at a remote receiver which will allow the received signal to be processed.

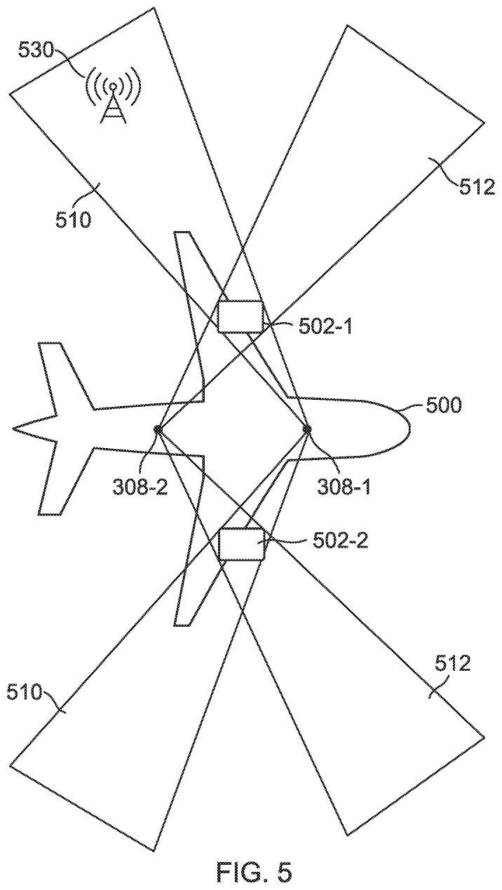

Referring to FIG. 5, a bottom view of an example aircraft 500 that includes the vehicle communication system 300 described above. As illustrated, the antennas 308-1 and 308-2 are spaced apart from each other. The spacing allows at least one of the radiated first and second transmission signals from one of the first and second antennas 308-1 and 308-2 to reach its intended ground station 530. As illustrated in FIG. 5, engine 502-1 creates an engine blockage area 510 of the first radiated split transmission signals from the first antenna 308-1 and an engine blockage area 512 of the second radiated split transmission signals from the second antenna 308-2. Similarly, engine 502-2 creates an engine blockage area 510 of the first radiated split transmission signals from the first antenna 308-1 and an engine blockage area 512 of the second radiated split transmission signals from the second antenna 308-2.

As the example in FIG. 5 illustrates, an element (engine 502-1) of the aircraft 500 creates an engine blockage area 510 that prevents a first radiated split transmission signal from the first antenna 308-1 from reaching the ground station 530. However, since the second radiated split transmission signal from the second antenna is not blocked from reaching the ground station 530 by either engine 502-1 or 502-2, the transmission signal still reaches the ground station 530 as desired.

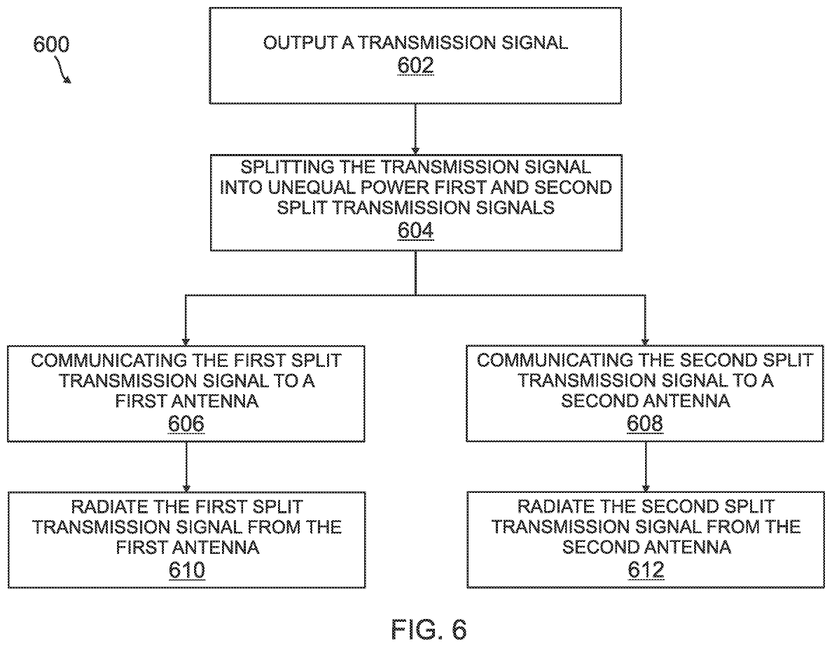

Referring to FIG. 6, a communication flow diagram 600 is illustrated. As illustrated the flow diagram is provided as a series of sequential blocks. The sequence of the blocks may occur is different order or in parallel in other embodiments. Hence, embodiments are not limited by the sequence set out in flow diagram 600.

As illustrated in FIG. 6, the process starts at block (602) by outputting a transmission signal. The outputted transmission signal may be a signal desired to be received at a remote location. The outputted signal is outputted by a transmitter. The transmission signal is then power split into unequal first and second split transmission signals at block (604). As discussed above, the power splitter splits the power of the transmitted signal unequally so that even if destructive interference occurs between the first and second split transmission signals, the signals will not totally cancel each other out. In an embodiment, the splitter is a passive power splitter.

The first split transmission signal is communicated to a first antenna at block (606) and the second split transmission signal is communicated to a second antenna at block (608). The first split transmission signal is radiated from the first antenna at block (610) and the second split transmission signal is radiated from the second antenna at block (612). Even if one of the first and second split transmission signals is blocked, the other of the split transmission signal with make it a desired remote location such as a ground station.

### EXAMPLE EMBODIMENTS

Example 1 is a communication system for a vehicle. The system includes a transmitter, first and second antennas and a splitter. The transmitter outputs transmission signals. The second antenna is spaced from the first antenna to provide spatial diversity between the transmission signals radiated out by the first and second antennas. The splitter has an input that is in communication with an output of the transmitter. The splitter has a first output that is in communication with the first antenna and a second output that is in communication with the second antenna. The splitter is configured to provide an unequal passive power splitting between the first output and the second output of the splitter.

Example 2 includes the system of Example 1, wherein the splitter is a passive radio frequency (RF) power splitter configured to provide a select power loss at one of the first and second outputs to provide the signal power diversity between the first and second output of the splitter.

Example 3 includes the system of any of the Examples 1-2, wherein the select power loss is selected to result in the transmission signals being radiated to a remote location within a power link margin that enables communications when the transmission signals radiated out by the first and second antennas combine in anti-phase.

Example 4 includes the system of any of the Examples 1-3, wherein the transmitter is part of an air-to-ground system in an aircraft with the first and second antennas located on a bottom portion of the aircraft, the first and second antennas located to reduce an impact of signal blockage by an engine.

Example 5 includes the system of any of the Examples 1-4, further including a controller configured to control the transmitter in outputting the transmission signals and a memory in communication with the controller. The memory is configured to store operating instruction implemented by the controller.

Example 6 includes the system of any of the Examples 1-5, wherein the vehicle includes at least one member that blocks at least portion of the transmission signals radiated out by the first and second antennas.

Example 7 includes the system of Example 7, wherein the at least one member is an engine.

Example 8 is communication system for a vehicle. The system includes a transmitter to transmit transmission signals, a passive power splitter, first antenna and a second antenna. An input of the power splitter is in communication with the transmitter. The power splitter has a first output and a second output. The power splitter is configurated to provide an unequal power distribution between the first output and the second output. The first antenna is in communication with the first output of the power splitter. The second antenna is spaced from the first antenna and is in communication with the second output of the power splitter. The first and second antennas are configured to radiate the transmission signals to a remote location. A positioning of the first and second antennas allows the transmission signals to reach the remote location when at least a partial blockage of the transmission signal occurs as a result of at least one element of the vehicle causing at least one signal blockage area that blocks the radiation of the transmission signal from at least one of the first and second antennas to the remote location.

Example 9 includes the system of Example 8, wherein the splitter is a passive radio frequency (RF) power splitter configured to provide a select power loss at one of the first and second outputs to provide signal power diversity between the first and second output of the splitter.

Example 10 includes the system of Example 9, wherein the select power loss is selected to result in the transmission signals being radiated to a remote location within a power link margin that allows communications when the transmission signals radiated out by the first and second antennas combine in anti-phase.

Example 11 includes the system of any of the Examples 8-10, wherein the transmitter is part of an air-to-ground system in an aircraft with the first and second antennas located on a bottom portion of the aircraft, at least one element is at least one engine of the aircraft causing a signal blockage area.

Example 12 includes the system of any of the Examples 8-11, wherein the remote location includes a ground station.

Example 13 includes the system of any of the Examples 8-12, wherein the unequal power distribution between the first output and the second output allows for the transmission signal to reach the remote location even when the radiated transmission signals from the first and second antenna combine to destructively interfere with each other.

Example 14 includes the system of any of the Examples 8-13, further including a controller and a memory. The controller is configured to control the transmitter in outputting the transmission signals. The memory is in communication with the controller. The memory is configured to store operating instruction implemented by the controller.

Example 15 includes a method of operating a vehicle communication system, the method including transmitting a transmission signal to be communicated to a remote location with a transmitter; splitting the transmission signal with a passive power splitter having unequal first and second outputs to generate a first split transmission signal of a first power from the first output and a second split transmission signal of a second different power from the second output; radiating out the first split transmission signal of the first power from a first antenna; and radiating out the second split transmission signal of the second power from second antenna that is spaced from the first antenna so that at least one of the first split transmission signal and the second split transmission signal will reach a remote location when an element of the vehicle blocks another of the first split transmission signal and the second split transmission signal.

Example 16 includes the method of Example 15, further including selecting the passive power splitter to provide the unequal power first and second outputs to allow the at least one of the first split transmission signal and the second split transmission to reach a remote location even when destructive interference occurs between the first split transmission signal and the second split transmission signal.

Example 17 includes the method of any of the Examples 15-16, wherein the passive power splitter is a passive radio frequency (RF) power splitter configured to provide a select power loss at one of the first and second outputs.

Example 18 includes the method of any of the Examples 15-17, wherein the element blocking the other of the first split transmission signal and the second split transmission is an engine.

Example 19 includes the method of any of the Examples 15-18, further including controlling the transmitter with a controller.

Example 20 includes the method of any of the examples 15-19, further including providing a select signal power loss at one of the first and second outputs to provide the unequal first and second outputs of the passive power splitter.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A communication system for a vehicle, the system comprising:
a transmitter to output transmission signals;
a first antenna;
a second antenna spaced from the first antenna to provide spatial diversity between the transmission signals radiated out by the first and second antennas; and
a splitter having an input in communication with an output of the transmitter, the splitter having a first output in communication with the first antenna and a second output in communication with the second antenna, the splitter configured to provide an unequal passive power splitting between the first output and the second output of the splitter.

2. The system of claim 1, wherein the splitter is a passive radio frequency (RF) power splitter configured to provide a select power loss at one of the first and second outputs to provide the signal power diversity between the first and second output of the splitter.

3. The system of claim 2, wherein the select power loss is selected to result in the transmission signals being radiated to a remote location within a power link margin that enables communications when the transmission signals radiated out by the first and second antennas combine in anti-phase.

4. The system of claim 1, wherein the transmitter is part of an air-to-ground system in an aircraft with the first and second antennas located on a bottom portion of the aircraft, the first and second antennas located to reduce an impact of signal blockage by an engine.

5. The system of claim 1, further comprising:
a controller configured to control the transmitter in outputting the transmission signals; and
a memory in communication with the controller, the memory configured to store operating instruction implemented by the controller.

6. The system of claim 1, wherein the vehicle includes at least one member that blocks at least a portion of the transmission signals radiated out by the first and second antennas.

7. The system of claim 6, wherein the at least one member is an engine.

8. A communication system for a vehicle, the system further comprising:
a transmitter to transmit transmission signals;
a passive power splitter, an input of the power splitter in communication with the transmitter, the power splitter having a first output and a second output, the power splitter configurated to provide an unequal power distribution between the first output and the second output;
a first antenna in communication with the first output of the power splitter; and
a second antenna spaced from the first antenna in communication with the second output of the power splitter, the first and second antennas configured to radiate the transmission signals to a remote location, a positioning of the first and second antennas allowing the transmission signals to reach the remote location when at least a partial blockage of the transmission signal occurs as a result of at least one element of the vehicle causing at least one signal blockage area that blocks the radiation of the transmission signal from at least one of the first and second antennas to the remote location.

9. The system of claim 8, wherein the splitter is a passive radio frequency (RF) power splitter configured to provide a select power loss at one of the first and second outputs to provide signal power diversity between the first and second output of the splitter.

10. The system of claim 9, wherein the select power loss is selected to result in the transmission signals being radiated to a remote location within a power link margin that allows communications when the transmission signals radiated out by the first and second antennas combine in anti-phase.

11. The system of claim 9, wherein the transmitter is part of an air-to-ground system in an aircraft with the first and second antennas located on a bottom portion of the aircraft, the at least one element is at least one engine of the aircraft causing a signal blockage area.

12. The system of claim 8, wherein the remote location includes a ground station.

13. The system of claim 8, wherein the unequal power distribution between the first output and the second output allows for the transmission signal to reach the remote location even when the radiated transmission signals from the first antenna and the second antenna combine to destructively interfere with each other.

14. The system of claim 8, further comprising:
a controller configured to control the transmitter in outputting the transmission signals; and
a memory in communication with the controller, the memory configured to store operating instruction implemented by the controller.

15. A method of operating a vehicle communication system, the method comprising:
transmitting a transmission signal to be communicated to a remote location with a transmitter;
splitting the transmission signal with a passive power splitter having unequal first and second outputs to generate a first split transmission signal of a first power from the first output and a second split transmission signal of a second different power from the second output;
radiating out the first split transmission signal of the first power from a first antenna; and
radiating out the second split transmission signal of the second power from second antenna that is spaced from the first antenna so that at least one of the first split transmission signal and the second split transmission signal will reach a remote location when an element of the vehicle blocks another of the first split transmission signal and the second split transmission signal.

16. The method of claim 15, further comprising:
selecting the passive power splitter to provide the unequal power first and second outputs to allow the at least one of the first split transmission signal and the second split
transmission to reach a remote location even when destructive interference occurs between the first split transmission signal and the second split transmission signal.

17. The method of claim 15, wherein the passive power splitter is a passive radio frequency (RF) power splitter configured to provide a select power loss at one of the first and second outputs.

18. The method of claim 15, wherein the element blocking the another of the first split transmission signal and the second split transmission is an engine.

19. The method of claim 15, further comprising:
controlling the transmitter with a controller.

20. The method of claim 15, further comprising:
providing a select signal power loss at one of the first and second outputs to provide the unequal first and second outputs of the passive power splitter.
